(19) United States
(12) Patent Application Publication
(10) Pub. No.: US 2019/0066688 A1
(43) Pub. Date: Feb. 28, 2019

(54) DISTRIBUTED VOICE CONTROL SYSTEM

(71) Applicant: YUTOU TECHNOLOGY (HANGZHOU) CO., LTD., Zhejiang (CN)

(72) Inventors: Hongtao Wu, Zhejiang (CN); Tao Jiang, Zhejiang (CN); Peng Gao, Zhejiang (CN); Wenjie Xiang, Zhejiang (CN); Jian Xu, Zhejiang (CN)

(21) Appl. No.: 16/079,956

(22) PCT Filed: Feb. 20, 2017
(86) PCT No.: PCT/CN2017/074076

§ 371 Date: Aug. 24, 2018

(30) Foreign Application Priority Data
Mar. 30, 2016 (CN) 201610195787.0

(51) Int. Cl. G10L 15/30; G10L 15/22; H04R 1/40

(52) U.S. Cl. CPC G10L 15/30; G10L 15/22; H04R 2201/401; H04R 1/403; G10L 2015/223; H04R 1/406

(57) ABSTRACT

Disclosed is a distributed voice control system comprising a main body portion and at least two auxiliary portions. The main body portion is provided with a master processor; a master microphone array connected to the master processor and used for acquiring acoustic signals of a user within a first set distance; and a master loudspeaker connected to the master processor and used for playing a voice message. The auxiliary portions are distributed in different spatial positions, wherein each is in wireless signal connection with the main body portion, and each of the auxiliary portions is provided with a sub-processor, a sub-microphone array connected to the sub-processor and used for capturing acoustic signals within a second set distance, and a sub-loudspeaker connected to the sub-processor and used for playing a voice message.

### CROSS-REFERENCE TO RELATED APPLICATIONS

The present application claims priority to and the benefit of Chinese Patent Application No. CN 201610195787.0 filed on Mar. 30, 2016, the entire content of which is incorporated herein by reference.

### BACKGROUND OF THE INVENTION

### 1. Field of the Invention

The present invention relates to a technical field of electronic techniques, especially to a distributed voice control system.

### 2. Description of the Related Art

An intelligent voice assistant can be used by a user for controlling smart home devices through voice; an intelligent voice assistant in smart home system is used to manage smart home devices in a way of voice interaction. However, in the prior art, a voice control system usually utilizes microphones on mobile terminals or voice capture devices of smart home devices to capture voice signals, the solution is limited by voice capture range of the microphones on mobile terminals or the voice capture devices of smart home devices, for example, if a user stands far away from a mobile terminal or a smart home device, capture and identification of voices will not be achieved effectively.

### SUMMARY OF THE INVENTION

Aiming at the technical problems of lack of effectivity for capture and identification of voices in the prior art, the invention provides a distributed voice control system, for overcoming the defects in the prior art.

The technical solution specifically comprises:

A distributed voice control system, comprising:

a main body, which is provided with:
a main processor;
a main microphone array, connected with the main processor, configured to capture voice signals of a user in the first setting distance range;
a main loudspeaker, connected with the main processor, configured to play voice messages;

at least two auxiliary parts, distributed in different locations of space, wherein each of the auxiliary parts is wirelessly connected with the main body, and each of the auxiliary parts is provided with:
a sub-processor;
a sub-microphone array, connected with the sub-processor, configured to capture voice signals of a user in the second setting distance range;
a sub-loudspeaker, connected with the sub-processor, configured to play voice messages.

Preferably, in the distributed voice control system, a main luminous array comprising 6 to 8 LEDs is disposed on the main body; when the main body receives a voice signal, the main luminous array on the main body shines.

Preferably, in the distributed voice control system, a sub-luminous array comprising 1 to 4 LEDs is disposed on the auxiliary part; when the auxiliary part receives a voice signal and responds to the voice signal, the sub-luminous array shines.

Preferably, in the distributed voice control system, the main microphone array consists of 8 microphones arranged in circular array; and/or

the sub-microphone array consists of 2 to 8 microphones.

Preferably, in the distributed voice control system, the main body and the multiple auxiliary parts are wirelessly connected through Bluetooth or Wi-Fi.

Preferably, in the distributed voice control system, the main processor includes a first type of application processor and a heterogeneous multi-core digital signal processor; wherein the heterogeneous multi-core digital signal processor is configured to process voice signals captured by the main microphone array.

Preferably, in the distributed voice control system, the main processor includes a second type of application processor and a multi-core microcontroller; wherein the second type of application processor is configured to process voice signals captured by the main microphone array.

Preferably, in the distributed voice control system, the sub-processor includes a third type of application processor; wherein the third type of application processor, which runs on Android operating system, is independent of the main processor and configured to process voice signals captured by the sub-microphone array.

Preferably, in the distributed voice control system, the sub-processor includes an ARM processor and a digital signal processor; wherein the digital signal processor, which is independent of the main processor, is configured to process voice signals captured by the sub-microphone array.

Preferably, in the distributed voice control system, the sub-processor includes a microcontroller; wherein the microcontroller, which runs on Linux operating system, performs information interaction with the main body in wireless way.

The advantageous effects of the invention includes: the technical solution provides a distributed voice control system, which can capture voice messages effectively and identify them correctly in various locations of the space, beneficial for improving user experience.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is a structure diagram of a main body and an auxiliary part according to the invention.

FIG. 2 is a structure diagram of a main body and multiple auxiliary parts according to the invention.

FIG. 3 is a structure diagram of a main processor according to a preferred embodiment of the invention.

FIG. 4 is a structure diagram of a main processor according to another preferred embodiment of the invention.

FIG. 5 is a structure diagram of a sub-processor according to a preferred embodiment of the invention.

FIG. 6 is a structure diagram of a sub-processor according to another preferred embodiment of the invention.

FIG. 7 is a structure diagram of a sub-processor according to another preferred embodiment of the invention.

### DETAILED DESCRIPTIONS

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

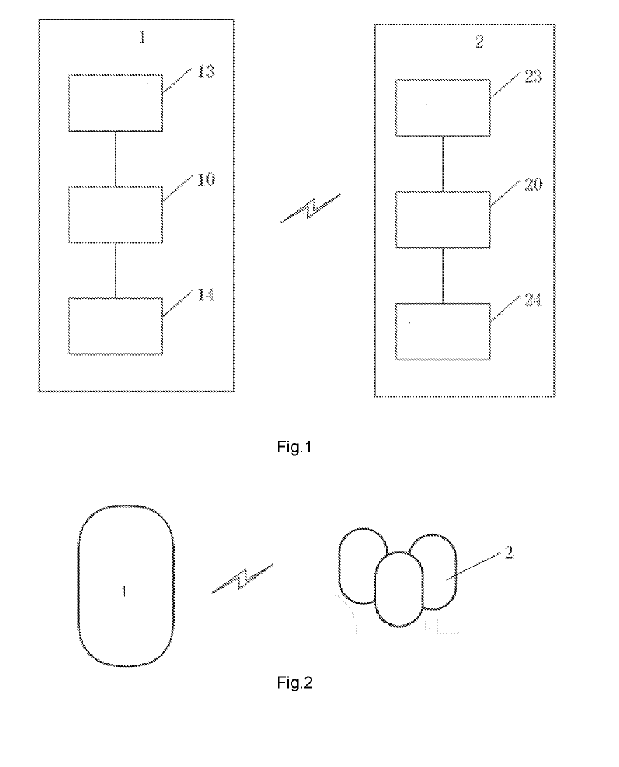

As shown in FIG. 1 to FIG. 7, there is a distributed voice control system, wherein it comprises:

a main body 1, which is configured with:
a main processor 10;
a main microphone array 13, connected with the main processor 10, configured to capture voice signals of a user in the first setting distance range;
a main loudspeaker 14, connected with the main processor 10, configured to play voice messages;

at least two auxiliary parts 2, distributed in different locations of space, wherein each of the auxiliary parts 2 is wirelessly connected with the main body 1, and each of the auxiliary parts 2 is provided with:
a sub-processor 20;
a sub-microphone array 23, connected with the sub-processor 20, configured to capture voice signals of a user in the second setting distance range;
a sub-loudspeaker 24, connected with the sub-processor 20, configured to play voice messages.

At least two auxiliary parts 2 provided in the present invention could be used to extend the scope of capturing voices, the main body 1 combined with the auxiliary part 2 is appropriate for implementing voice capture and voice interaction in larger scope; wherein, the auxiliary part 2 could treat voice signals independently, or send voice signals to the main body 1 for treatment by the main body 1. The at least two auxiliary parts 2 and the main body 1 could be arranged in geometric shape, so as to cover any corner in the space area, achieving effective capture and identification of voices.

In the distributed voice control system, the main microphone array 13 consists of 8 microphones arranged in circular array; wherein the circular array of 8 microphones has a diameter of 80 mm. Additionally, in a preferred embodiment, the main microphone array 13 consists of 8 microphones arranged in circular array with a radius of 80 mm, and another microphone disposed in the center of the circular array.

In the distributed voice control system, the sub-microphone array 23 consists of 2˜8 microphones.

In the distributed voice control system, the main body 1 and the multiple auxiliary parts 2 are wirelessly connected through Bluetooth or Wi-Fi. In preferred embodiments, the main body 1 and the multiple auxiliary parts 2 may support Wi-Fi 802.11 or BT4.0+EDR/BLE.

In the distributed voice control system, a main luminous array comprising 6˜8 LEDs is disposed on the main body 1; when the main body 1 receives a voice signal, the main luminous array on the main body shines. Furthermore, when the main processor 10 identifies the voice source direction of the captured voice signal, it instructs the LED in the voice source direction to shine.

In a preferred embodiment, a sub-luminous array comprising 1˜4 LEDs is disposed on the auxiliary part 2; when the auxiliary part 2 receives a voice signal and responds to the voice signal, the sub-luminous array shines.

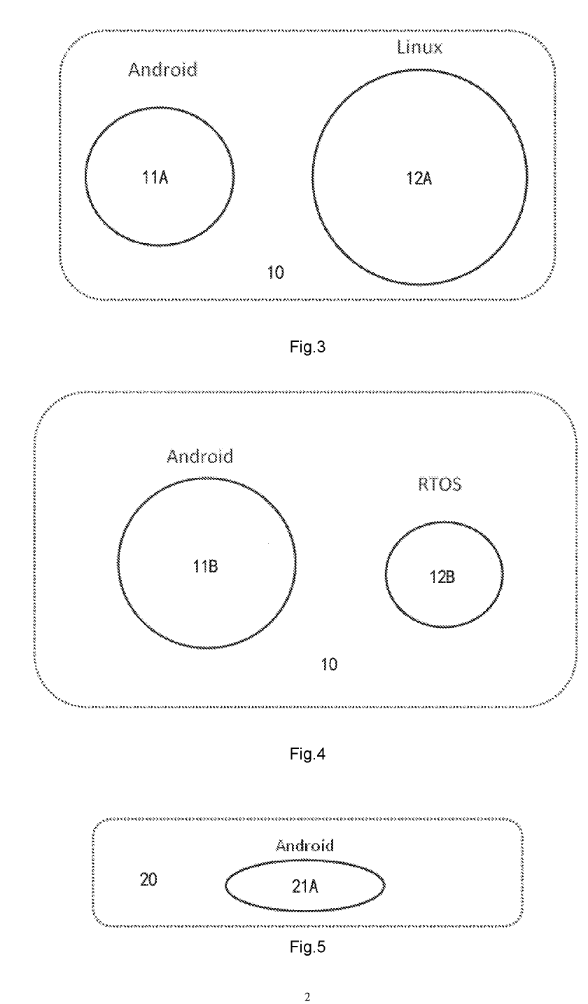

As shown in FIG. 3, in the distributed voice control system, the main processor 10 may include a first type of application processor 11A and a heterogeneous multi-core digital signal processor 12A; wherein the heterogeneous multi-core digital signal processor 12A is configured to process voice signals captured by the main microphone array 13.

As shown in FIG. 4, in the distributed voice control system, the main processor 10 includes a second type of application processor 11B and a multi-core microcontroller 12B; wherein the second type of application processor 11B is configured to process voice signals captured by the main microphone array 13.

The abovementioned structure could enable one processor to respond promptly and back feed voice command, and another processor to specialize in treatment of voice messages, so that the response speed of the system can be increased, and user experience can be improved.

As shown in FIG. 4, for example, the multi-core microcontroller 12B uses Linux system as Real Time Operating System (RTOS) for operating the multi-core microprocessor, for the purpose of processing external events or data in fast enough speed.

The first type of application processor 11A could be a low-end application processor, and the second type of application processor 11B could be a high-end application processor.

As shown in FIG. 5, in the distributed voice control system, the sub-processor 20 includes a third type of application processor 21A; wherein the third type of application processor 21A, which runs on Android operating system, is independent of the main processor 10 and configured to process voice signals captured by the sub-microphone array 23. The third type of application processor 21A could be a mid-end application processor.

As shown in FIG. 6, in the distributed voice control system, the sub-processor 20 includes an ARM processor and a digital signal processor 21B; wherein the digital signal processor, which is independent of the main processor 10, is configured to process voice signals captured by the sub-microphone array 23.

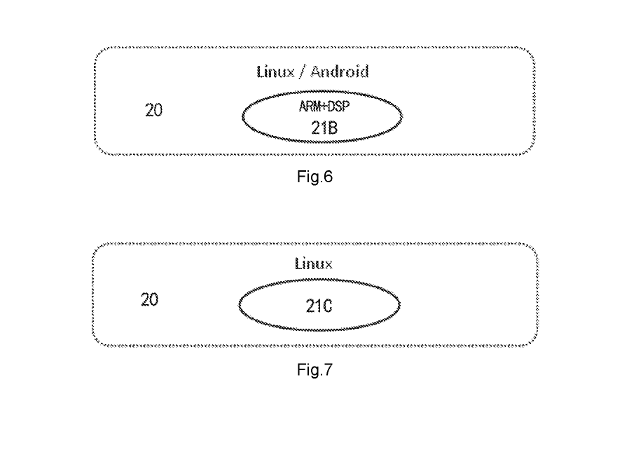

As shown in FIG. 7, in the distributed voice control system, the sub-processor 20 includes a microcontroller 21C; wherein the microcontroller 21C, which runs on Linux operating system, performs information interaction with the main body 1 in wireless way. As shown in FIG. 7, the function of the present invention is achieved by the combination of the sub-processor 20 and the main body 1.

The abovementioned technical solution provides a distributed voice control system, which can capture voice messages effectively and identify them correctly in various locations of the space, beneficial for improving user experience.

These embodiments shown above represent only preferred examples of the present invention and may therefore not be understood to be limiting of the embodiments and scope of the invention. Alternative embodiments that can be contemplated by the person skilled in the art are likewise included in the scope of the present invention.

What is claimed is:

1. A distributed voice control system, comprising:
a main body, which is provided with:
a main processor;
a main microphone array, connected with the main processor, configured to capture a voice signal of a user in a first setting distance range;
a main loudspeaker, connected with the main processor, configured to play voice messages;
at least two auxiliary parts, distributed in different locations of space, wherein each of the auxiliary parts is wirelessly connected with the main body, and each of the auxiliary parts is provided with:
a sub-processor;
a sub-microphone array, connected with the sub-processor, configured to capture a voice signal of a user in the second setting distance range;
a sub-loudspeaker, connected with the sub-processor, configured to play voice messages.

2. The distributed voice control system as claimed in claim 1, wherein a main luminous array is disposed on the main body, the main luminous array comprises 6 to 8 LEDs; when the main body receives the voice signal, the main luminous array on the main body shines.

3. The distributed voice control system as claimed in claim 1, wherein a sub-luminous array is disposed on the auxiliary part, the sub-luminous array comprises 1 to 4 LEDs; when the auxiliary part receives the voice signal and responds to the voice signal, the sub-luminous array shines.

4. The distributed voice control system as claimed in claim 1, wherein the main microphone array consists of 8 microphones arranged in circular array; and/or the sub-microphone array consists of 2 to 8 microphones.

5. The distributed voice control system as claimed in claim 1, wherein the main body and the plurality of auxiliary parts are wirelessly connected through Bluetooth or Wi-Fi.

6. The distributed voice control system as claimed in claim 1, wherein the main processor includes a first type of application processor and a heterogeneous multi-core digital signal processor; wherein the heterogeneous multi-core digital signal processor is configured to process voice signals captured by the main microphone array.

7. The distributed voice control system as claimed in claim 1, wherein the main processor includes a second type of application processor and a multi-core microcontroller; wherein the second type of application processor is configured to process voice signals captured by the main microphone array.

8. The distributed voice control system as claimed in claim 1, wherein the sub-processor includes a third type of application processor; wherein the third type of application processor, which runs on Android operating system, is independent of the main processor and configured to process voice signals captured by the sub-microphone array.

9. The distributed voice control system as claimed in claim 1, wherein the sub-processor includes an ARM processor and a digital signal processor; wherein the digital signal processor is independent of the main processor and is configured to process voice signals captured by the sub-microphone array.

10. The distributed voice control system as claimed in claim 1, wherein the sub-processor includes a microcontroller; wherein the microcontroller, which runs on Linux operating system, performs information interaction with the main body in wireless way.
